(19) United States
(12) Patent Application Publication
(10) Pub. No.: US 2013/0068599 A1
(43) Pub. Date: Mar. 21, 2013

(54) Switch

(71) Applicant: Hidetake Kikuchi, Tokyo (JP)

(72) Inventor: Hidetake Kikuchi, Tokyo (JP)

(21) Appl. No.: 13/610,980

(22) Filed: Sep. 12, 2012

(30) Foreign Application Priority Data
Sep. 15, 2011 (JP) 2011-201601
Sep. 10, 2012 (JP) 2012-198439

(51) Int. Cl. H01H 13/50

(52) U.S. Cl. 200/341

(57) ABSTRACT

There is provided a switch including a case, fixed electrodes provided in the case, a movable electrodes and a pressing member. The movable electrode is provided in the case, and is displaced between a first position where the fixed electrodes are electrically connected to each other and a second position where the fixed electrodes are insulated from each other. The pressing member displaces the movable electrode from the second position to the first position when a pressing force from outside is applied to the pressing member. The pressing member is elastically deformed by the pressing force so that a contact area between the pressing member and the movable electrode is increased.

### BACKGROUND

The present invention relates to a switch used in various types of miniature electronic devices and, more particularly, to a push switch mounted on a circuit board.

In a device of this type, a recess is formed in a case mounted on a circuit board, and a plurality of stationary and movable electrodes are disposed within the recess. The movable electrode is configured so as to be elastically displaceable between a first position where the plurality of fixed electrodes are brought into electrical conduction with each other and a second position where the fixed electrodes are brought out of electrical conduction. A pressing member is disposed so as to oppose the movable electrode situated at the second position in normal times. Upon receipt of pressing force from the outside, the pressing member displaces the movable electrode to the first position, whereupon the fixed electrodes are brought into electrical conduction with each other. When the pressing force is released, the movable electrode is elastically restored to the second position, whereupon the fixed electrodes are brought into a state where the fixed electrodes are non-conducting to each other (see, Patent Document 1).

A component formed by bonding a push element to a flexible film-shaped member is used as the pressing member. The push element is formed from a thermoplastic resin or a photo-curable resin and exhibits high rigidity. The push element is configured such that it is brought into contact with a movable electrode by an external pressing force, thereby displacing or deforming the movable electrode (see, Patent Document 2).
[Patent Document 1] JP-A-2010-129383
[Patent Document 2] JP-A-2010-118200

### SUMMARY

According to one aspect of the present invention, there is provided a switch comprising:

a case, configured to be mounted on a circuit board, and formed with a recess;

a plurality of fixed electrodes provided in the recess;

a movable electrode, provided in the recess, and configured to be displaced between a first position where the plurality of fixed electrodes are electrically connected to each other and a second position where the plurality of fixed electrodes are insulated from each other; and

a pressing member, covering the recess, and configured to displace the movable electrode from the second position to the first position when a pressing force from outside is applied to the pressing member, wherein

the pressing member is configured to be elastically deformed by the pressing force so that a contact area between the pressing member and the movable electrode is increased.

According to another aspect of the present invention, there is provided a switch comprising:

a case, configured to be mounted on a circuit board, and formed with a recess;

a plurality of fixed electrodes provided in the recess;

a movable electrode, provided in the recess, and configured to be displaced between a first position where the plurality of fixed electrodes are electrically connected to each other and a second position where the plurality of fixed electrodes are insulated from each other; and

a pressing member, covering the recess, and configured to displace the movable electrode from the second position to the first position when a pressing force from outside is applied to the pressing member, wherein

the pressing member is configured to be elastically deformed by the pressing force so that a volume of a portion of the pressing member situated in the recess in a state where the movable electrode is displaced to the first position is increased.

The switch may be configured such that: the pressing member includes a first part entirely covering the movable electrode and a second part protrudes from the first portion in a direction in which the movable electrode is displaced, and the first part and the second part are integrated.

The pressing member may be made from a material containing silicon rubber or fluorine-based rubber.

The pressing member may include a resin layer is provided on a surface thereof facing the movable electrode.

The resin layer may be made from a material containing any one of polyimide, a PEEK resin, and a fluorine-based resin.

The movable electrode may have elasticity.

### BRIEF DESCRIPTION OF DRAWINGS

FIG. 1 is a perspective view showing appearance of a push switch of a first embodiment of the invention;

FIGS. 2A to 2D show appearance of the push switch shown in FIG. 1 FIG. 2A is a top view, FIG. 2B is a front view, FIG. 2C is a bottom view, and FIG. 2D is a right side view;

FIG. 3 is an exploded perspective view of the push switch shown in FIG. 1;

FIG. 4 is a cross sectional view taken along line IV-IV shown in FIG. 2A;

FIGS. 5A to 5C are cross sectional views for explaining deformation of a pressing member when pressing force is exerted on the push switch shown in FIG. 1 from the outside; and

FIGS. 6A and 6B are cross sectional views for explaining deformation of the pressing member when pressing force is exerted on the push switch shown in FIG. 1 from the outside.

FIGS. 7A and 7B are cross sectional views for explaining deformation of the pressing member achieved when pressing force is exerted from the outside on the push switch of a second embodiment of the invention.

### DETAILED DESCRIPTION OF EXEMPLIFIED EMBODIMENTS

Along with recent miniaturization of electronic devices, miniaturization of constituent components of a switch itself has also been sought. As miniaturization of a movable electrode progresses correspondingly, load on the movable electrode stemming from contact of a push element exhibiting high rigidity on the movable electrode becomes relatively greater. As a consequence, the movable electrode sometimes becomes plastically deformed but incapable of due elastic restoration. Further, the push element exhibiting high rigidity cannot follow elastic deformation of the movable electrode, so that local concentration of stress occurs. This may incur breakage of the push element and peeling of an adhesive in addition to causing plastic deformation of the movable electrode.

Moreover, when an unexpected physical impact is inflicted on the switch, the push element exhibiting high rigidity collides with the movable electrode, which can cause plastic deformation of the movable electrode or breakage of the push element. Consequently, it becomes impossible to maintain functions originally required of the switch.

It is therefore one advantageous aspect of the present invention to provide a switch capable of an increase in longer operating life and enhancement of impact resistance by preventing load on a movable electrode while fulfilling a request for miniaturization.

An embodiment of the invention is hereunder described in detail by reference to the accompanying drawings. In the respective drawings hereinbelow used for explanation, a scale is appropriately changed in order to make sizes of respective members recognizable.

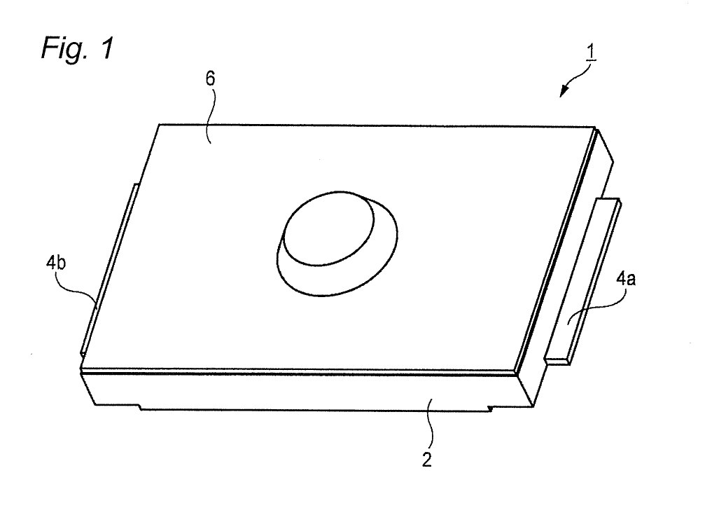

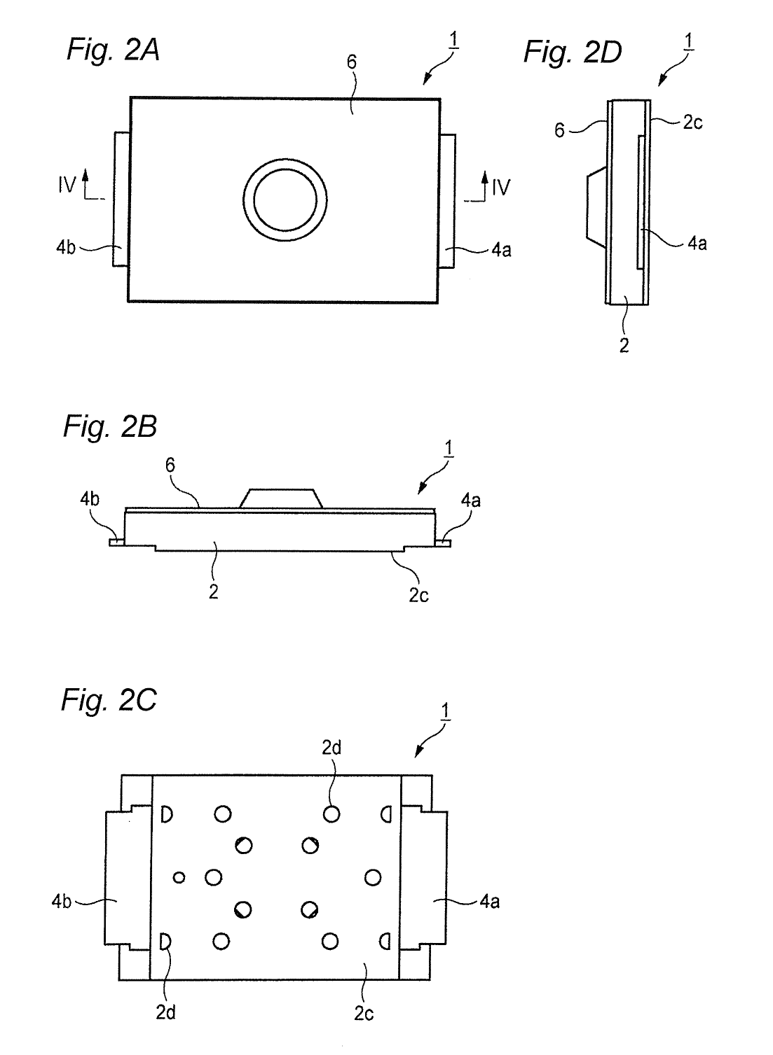

FIG. 1 shows a perspective view of a push switch 1 as a first embodiment of the switch of the invention, and FIGS. 2A to 2D show four orthogonal views of the same. FIG. 2A is a top view; FIG. 2B is a front view; FIG. 2C is a bottom view; and FIG. 2D is a right side view. A rear view is a symmetry of the front view, and a left side view is also a symmetry of the right side view. Therefore, these views are omitted for brevity.

As shown in the drawings, the push switch 1 assumes an appearance in which a pressing member 6 is put on an upper surface of a case 2 that is to be mounted on a circuit board and that is made of an insulating resin.

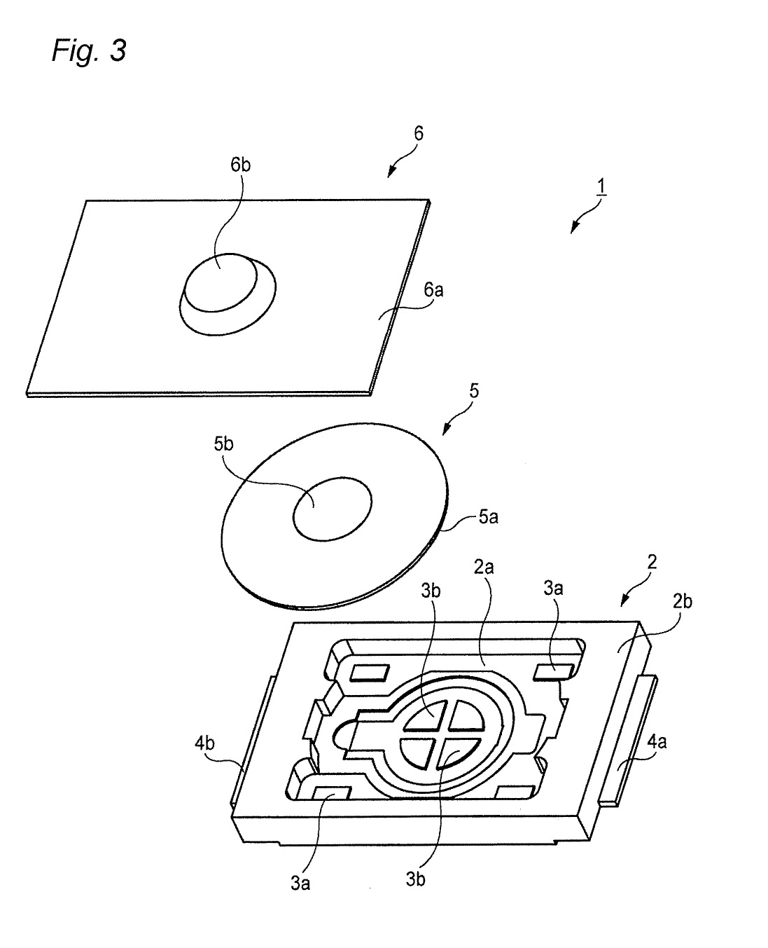

As shown in an exploded perspective view of FIG. 3, the case 2 has an upper surface 2b with a recess 2a formed therein. A plurality of first fixed electrodes 3a are positioned at four corners of a bottom of the recess 2a, and a plurality of second fixed electrodes 3b are positioned at the center of the bottom. The first fixed electrodes 3a and the second fixed electrodes 3b act as a plurality of fixed electrodes of the invention.

Each of the first fixed electrodes 3a are electrically connected to a first external connection terminal 4a in the case 2. Each of the second fixed electrodes 3b are electrically connected to a second external connection terminal 4b in the case 2. The first external connection terminal 4a and the second external connection terminal 4b are brought into contact with lands of wiring terminals formed on a mount surface of the circuit board by means of soldering.

A plurality of through holes 2d are formed in a bottom surface 2c of the case 2, and portions of any of the first fixed electrodes 3a, the second fixed electrodes 3b, the first external connection terminal 4a, and the second external connection terminal 4b remain bared from the respective through holes 2d. The respective bared portions are connected to predetermined lands formed on a mount surface of the circuit board through the through holes 2d by means of soldering.

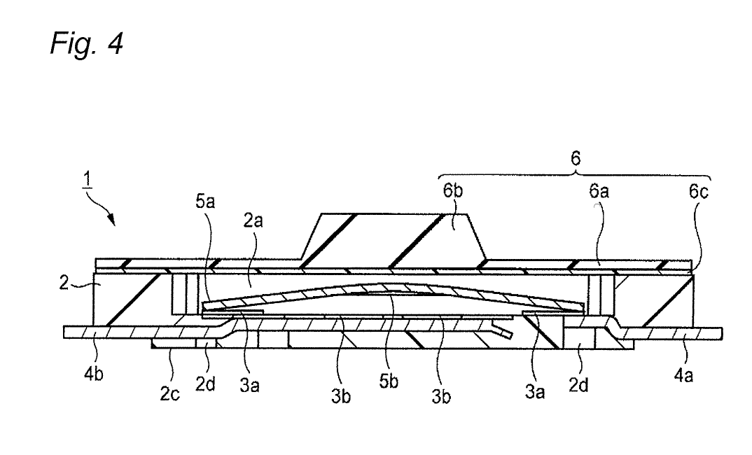

A movable electrode 5 is housed in the recess 2a of the case 2. The movable electrode 5 is an elastically deformable dome-shaped conductive member. As shown in a cross sectional view of FIG. 4, the movable electrode 5 is placed within the recess 2a such that an outer edge 5a contacts the first fixed electrodes 3a and that a center portion 5b opposes the second fixed electrodes 3b with a space therebetween. Specifically, the movable electrode 5 exhibits a swell in the upward direction in normal times.

The pressing member 6 is put on the upper surface 2b of the case 2 (see FIG. 3) so as to cover the recess 2a and undergoes pressing operation exerted from the above (the outside) by means of operation of an unillustrated button, or the like. By the pressing force stemming from the operation, the center portion 5b of the movable electrode 5 situated below the pressing member 6 is pressed by way of the pressing member 6. When the load exerted on the movable electrode 5 exceeds a predetermined value, the center portion 5b is inverted with tactile feel, thereupon exhibiting a swell in a downward direction and also contacting the second fixed electrodes 3b.

Accordingly, the first fixed electrodes 3a and the second fixed electrodes 3b enter electrical conduction with each other by way of the movable electrode 5. When pressing force is released, the center portion 5b restores to its original state (exhibits a swell in the upward direction) with tactile feel under self-restoration force (elasticity) of the movable electrode 5, whereupon the first fixed electrodes 3a and the second fixed electrodes 3b are released from the electrically conducted state. For this reason, the essential requirement is that at least one first fixed electrode 3a and at least one second fixed electrode 3b should be provided.

The movable electrode 5 can be displaced between a first position where the electrode brings a plurality of fixed electrodes into electrical conduction with each other and a second position where the electrode brings the fixed electrodes out of electrical conduction. Upon receipt of pressing force from the outside, the pressing member 6 displaces the movable electrode 5 from the second position to the first position.

The pressing member 6 has a flat portion 6a (a first portion) and a protruding portion 6b (a second portion). The flat portion 6a stretches so as to cover the entirety of the movable electrode 5, reaching the upper surface 2b of the case 2. Put another word, at least a portion of the upper surface 2b of the case 2 is covered with the flat portion 6a of the pressing member 6. The protruding portion 6b assumes a shape of a truncated cone and bulges upward at a center of the flat portion 6a; in other words, a bulging direction of the protruding portion 6b is in line with a direction where the movable electrode 5 is displaced.

The flat portion 6a and the protruding portion 6b are formed from a material including; for instance, silicon rubber or fluorine-based rubber, and exhibit a high degree of flexibility and elasticity. The flat portion 6a and the protruding portion 6b are formed so as to make up an integrated structure.

The word “integrated structure” designates a monolithic state in which a boundary between the flat portion 6a and the protruding portion 6b is made of the same material and that the flat portion 6a and the protruding portion 6b are continuous. The word is used to express that the monolithic state is distinguished from a state in which two or more members that are formed from different materials and that exhibit different characteristics are integrated by means of bonding or welding.

Since silicon rubber and fluorine-based rubber exhibit heat resistance, the rubber is useful when reflow treatment is used for soldering that is performed at the time of the push switch 1 being mounted on a circuit board.

As shown in FIG. 4, the pressing member 6 has a resin layer 6c on an underside of the flat portion 6a; namely, a side of the pressing member 6 facing the movable electrode 5. The resin layer 6c is formed from a material containing a thermosetting resin or a thermoplastic resin which is polyimide, a PEEK (polyether ether ketone) resin, or a fluorine-based resin. The thermoplastic resin layer 6c is bonded to the entire undersurface of the flat portion 6a by use of an appropriate adhesive.

Presence of the resin layer 6c makes it possible to prevent breakage of the thin, soft flat portion 6a, which would otherwise be caused when the thin, soft flat portion 6a repeatedly contacts the movable electrode. This also contributes to lengthening of operating life of the push switch 1. Moreover, since polyimide, the PEEK (polyether ether ketone) resin, and the fluorine-based resin exhibit heat resistance, the materials are useful when reflow treatment is used for soldering that is performed at the time of the push switch 1 being mounted on a circuit board.

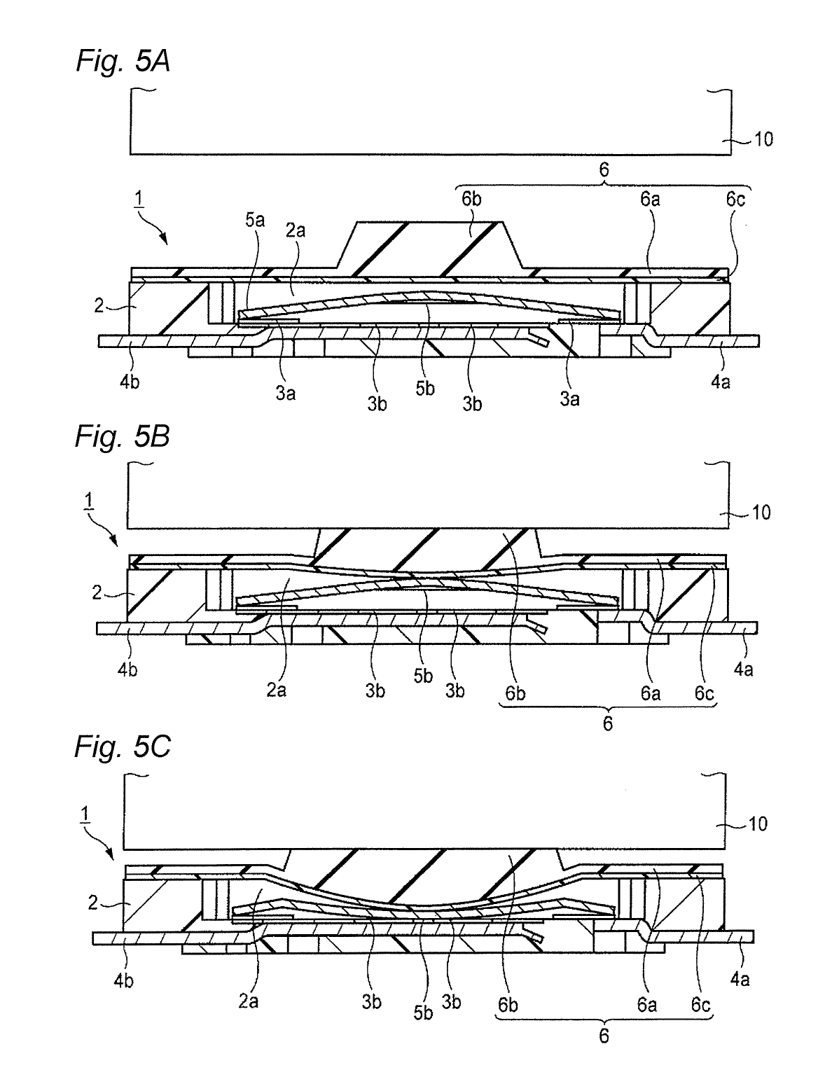

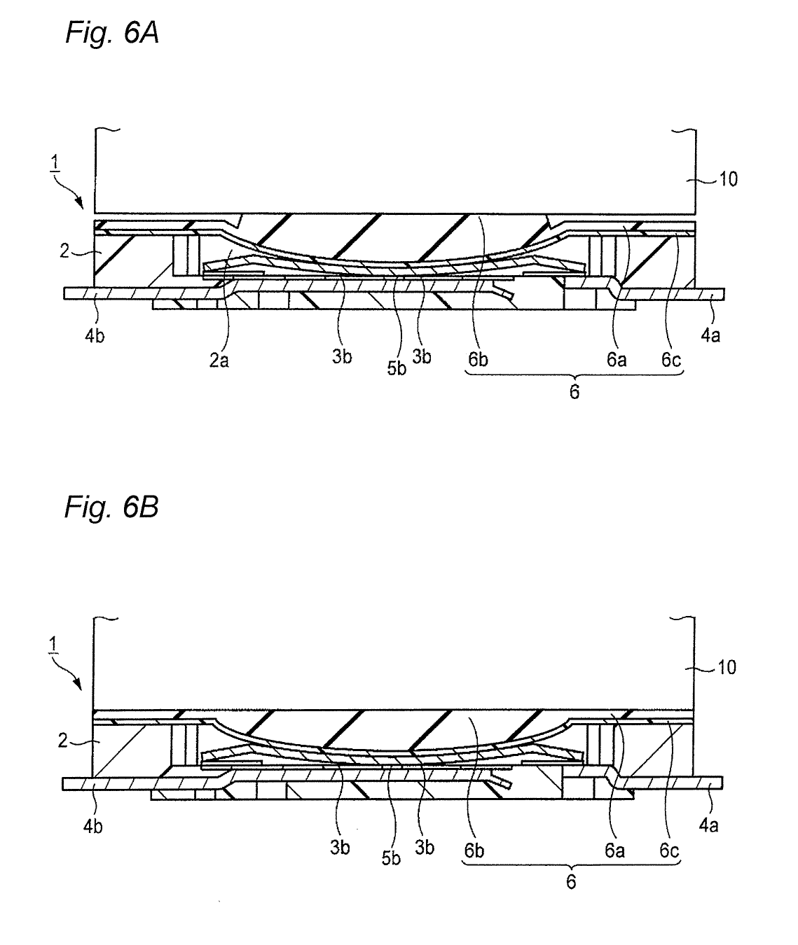

By reference to FIGS. 5 and 6, operations of the respective portions performed when the push switch 1 is actuated are now described in detail. In the drawings, only the push switch 1 is illustrated in cross section as is shown in FIG. 4.

FIG. 5A shows a normal state; namely, a state in which pressing force originating from an operation member 10, like a button, is not exerted on the push switch 1. The protruding portion 6b of the pressing member 6 holds its original state and remains protruding upward, to thus oppose the operation member 10. The movable electrode 5 is housed in the recess of the case 2 while protruding upward. The center portion 5b of the movable electrode 5 and the second fixed electrodes 3b remain out of contact with each other. Therefore, the first fixed electrodes 3a and the second fixed electrodes 3b (the first external connection terminal 4a and the second external connection terminal 4b) remain out of electrical conduction with each other.

When pressing force is exerted from the outside in such a way that the operation member 10 is downwardly displaced, a portion of the protruding portion 6b enters the recess 2a of the case 2, as shown in FIG. 5B, while the protruding portion 6b of the pressing member 6 is elastically deformed so as to be collapsed by the operation member 10. As a result, the protruding portion 6b acts as a so-called push element, thereby presses the movable electrode 5 downwardly.

Since the movable electrode 5 attempts to maintain its swell in the upward, load exerted on the movable electrode 5 and the pressing member 6 gradually increases. As a consequence, the protruding portion 6b is elastically deformed so as to be crushed further. Thus, a contact area between the movable electrode 5 and the pressing member 6 gradually increases.

When the load exerted on the movable electrode 5 exceeds a predetermined value, the center portion 5b is inverted with a tactile feel, to thus exhibit a swell in the downward as shown in FIG. 5C. The movable electrode 5 is displaced to the first position so that the center portion 5b and the second fixed electrodes 3b contact each other, and the first fixed electrodes 3a and the second fixed electrodes 3b are electrically connected to each other by way of the movable electrode 5. Thereby, the first external connection terminal 4a and the second external connection terminal 4b are electrically connected to each other. A portion of the load exerted by the operating member 10 is released by deformation of the movable electrode 5.

When the operating member 10 keeps on undergoing pressing force even after the movable electrode 5 has contacted the second fixed electrodes 3b (i.e., the movable electrode 5 has been displaced to the first position), the load exerted on the movable electrode 5 and the pressing member 6 again increases because the movable electrode 5 cannot be deformed any further. Therefore, as shown in FIG. 6A, the protruding portion 6b is elastically deformed so as to be further crushed, whereupon the volume of a portion of the pressing member 6 situated in the recess 2a of the case 2 gradually increases.

The operating member 10 is downwardly displaced by additional elastic deformation of the pressing member 6, whereupon a portion of the operating member 10 contacts the flat portion 6a of the pressing member 6 with time as shown in FIG. 6B. The operating member 10 is supported on the upper surface 2b of the case 2 by way of the flat portion 6a. A dimension of the protruding portion 6b and a dimension of the recess 2a are respectively determined such that the entirety of the protruding portion 6b elastically deformed in this state is housed in the recess 2a of the case 2. Consequently, the elastically deformed protruding portion 6b protrudes downwardly when compared with the flat portion 6a.

Even when the pressing force is further continually exerted on the operating member 10 in this state, the load is received by the upper surface 2b of the case 2, so that additional load is not exerted on the movable electrode 5 and the pressing member 6.

When the pressing force exerted on the operating member 10 is canceled, the center portion 5b restores an upward swell with tactile feel by self restoration force (elasticity) of the movable electrode 5 (i.e., the movable electrode 5 is displaced to the second position), whereupon the first fixed electrodes 3a and the second fixed electrodes 3b are released from an electrically conducted state. The protruding portion 6b also upwardly protrudes higher than the flat portion 6a by the self restoration force (elasticity) of the pressing member 6. As a consequence of being brought back upwardly, the operating member 10 returns to its initial state shown in FIG. 5A.

In the switch of the embodiment having the foregoing configuration, the pressing member 6 is elastically deformed by pressing force exerted from the outside (the operation member 10), whereby the pressing member 6 acts as a push element with an increase in contact area between the pressing member 6 and the movable electrode 5. As a consequence, the load stemming from the pressing force can be dispersed, so that local concentration of the load on the movable electrode 5 can be avoided. Plastic deformation of the movable electrode 5 can therefore be prevented, and the operating life of the push switch 1 can be extended while a request for miniaturization is fulfilled.

Since the pressing member 6 is elastically deformed so as to follow elastic deformation of the movable electrode 5, the pressing member 6 can absorb physical impact occurred during elastic deformation of the movable electrode 5. Further, plastic deformation of the movable electrode 5 can be prevented by avoiding local concentration of stress stemming from deformation. Moreover, the protruding portion 6b substantially acting as the push element is integrated with the flat portion 6a; hence, the pressing member 6 is not broken. Accordingly, the operating life of the push switch 1 can be extended while a request for miniaturization is fulfilled.

Even when external pressing force is continually exerted on the movable electrode 5 after the movable electrode 5 has contacted the second fixed electrodes 3b (i.e., the movable electrode 5 has been displaced to the first position), the pressing member 6 is elastically deformed by the pressing force, so that the volume of the portion of the pressing member 6 situated in the recess 2a of the case 2 increases.

Such a structure makes it possible to absorb excessive load exerted on the movable electrode 5 by means of elastic deformation of the pressing member 6. Therefore, plastic deformation of the movable electrode 5, which would otherwise be caused by continued exertion of excessive load on the movable electrode 5 after elastic deformation of the same, can be prevented. Moreover, breakage of the pressing member 6, which would otherwise be caused by such a load, also does not occur. Therefore, the operating life of the push switch 1 can be extended while a request for miniaturization is fulfilled.

Even when the operating member 10 is displaced by unexpected physical impact, the pressing member 6 can absorb the impact by elastic deformation. Further, by means of self restoration force (elasticity) of the pressing member 6, the operating member 10 is restored to its original position, so that the push switch 1 can maintain a state in which the original function of the push switch 1 can be exhibited. Consequently, impact resistance of the push switch 1 can be enhanced while a request for miniaturization is fulfilled.

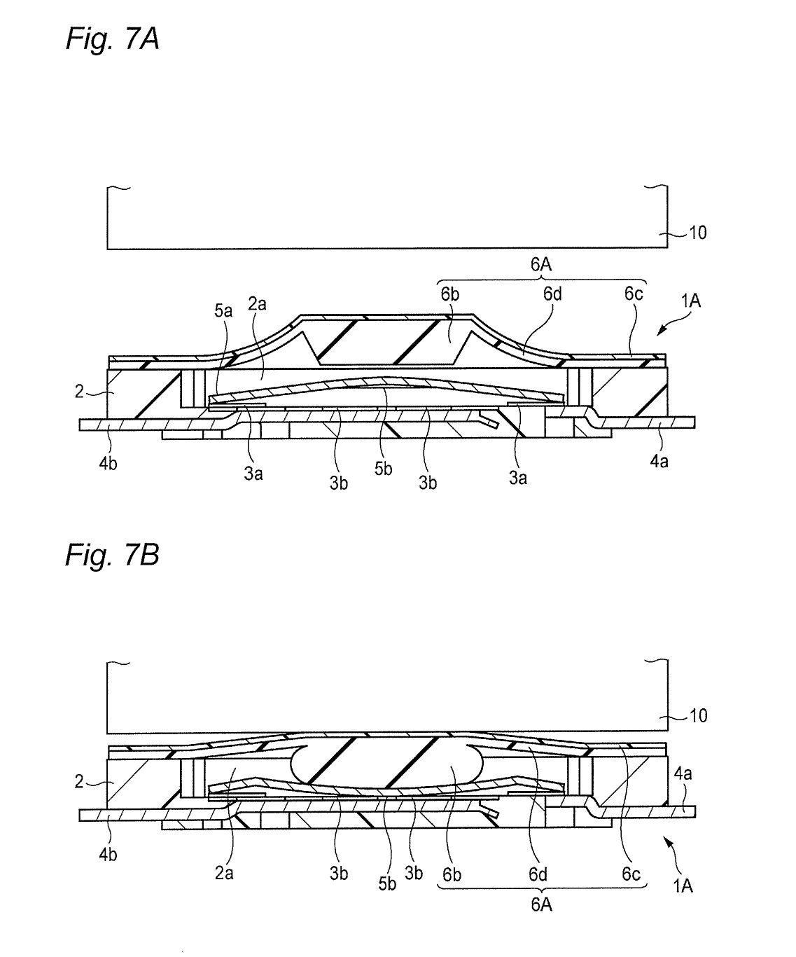

A push switch 1A of a second embodiment of the invention is now described by reference to FIGS. 7A and 7B. The constituent elements that are substantially identical with their counterparts of the push switch 1 described in connection with the first embodiment are assigned the same reference numerals, and their repeated explanations are omitted.

The push switch 1A of the embodiment has a pressing member 6A structurally differing from the pressing member 6 of the push switch 1 of the first embodiment. The pressing member 6A has the protruding portion 6b, the resin layer 6c, and a supporting portion 6d.

The supporting portion 6d serving as a first portion of the pressing member is extended so as to cover the entirety of the movable electrode 5, reaching the upper surface 2b of the case 2. In other words, at least a portion of the upper surface 2b of the case 2 is covered with the supporting portion 6d of the pressing member 6A.

The protruding portion 6b serving as a second portion of the pressing member is supported at a center area of the supporting portion 6d so as to protrude in a downward direction. Specifically, a direction of projection of the protruding portion 6B coincides with a direction of displacement of the movable electrode 5.

The supporting portion 6d and the protruding portion 6b are formed from a material containing; for instance, a silicone rubber or fluorine-based rubber, and exhibit resilience as well as abundant flexibility. Moreover, the supporting portion 6d and the protruding portion 6b are formed so as to make up a monolithic structure.

The pressing member 6A has the thermoplastic resin layer 6c on an upper surface of the supporting portion 6d; namely, the other side of the side of the supporting portion 6d that faces the movable electrode 5. The resin layer 6c is formed from a material containing a thermosetting resin or a thermoplastic resin which is polyimide, a PEEK (polyetheretherketone) resin, or a fluorine-based resin, and bonded to an entire upper surface of the supporting portion 6d by use of an appropriate adhesive.

FIG. 7A shows a normal state; namely, a state in which pressing force originating from the operation member 10, such as a button, is not exerted on the push switch 1A. The protruding portion 6b of the pressing member 6A protrudes downwardly while retaining its original shape, opposing the movable electrode 5. The movable electrode 5 is housed in the recess of the case 2 while protruding upward. The center portion 5b of the movable electrode 5 and the second fixed electrodes 3b remain out of contact with each other. Therefore, the first fixed electrodes 3a and the second fixed electrodes 3b (the first external connection terminal 4a and the second external connection terminal 4b) remain out of electrical conduction with each other.

When pressing force is exerted from the outside in such a way that the operation member 10 is downwardly displaced, the protruding portion 6b of the pressing member 6A enters the recess 2a of the case 2 as shown in FIG. 7B, thereupon contacting the movable electrode 5. The protruding portion 6b presses the movable electrode 5 in the downward direction while being elastically deformed so as to collapse with downward displacement of the operation member 10. More specifically, the protruding portion 6b acts as a so-called push element.

Since the movable electrode 5 attempts to maintain its swell in the upward direction, load exerted on the movable electrode 5 and the pressing member 6A gradually increases. Consequently, the protruding portion 6b is elastically deformed so as to collapse further, whereby a contact area between the movable electrode 5 and the pressing member 6A gradually increases.

When the load exerted on the movable electrode 5 exceeds a predetermined value, the center portion 5b is inverted with a tactile feel, to thus exhibit a swell in the downward. The center portion 5b and the second fixed electrodes 3b thereby contact each other (i.e., the movable electrode 5 is displaced to the first position), and the first fixed electrodes 3a and the second fixed electrodes 3b (i.e., the first external connection terminal 4a and the second external connection terminal 4b) are electrically connected to each other by way of the movable electrode 5. A portion of the load exerted by the operation member 10 is released by deformation of the movable electrode 5.

When the operation member 10 keeps on undergoing pressing force even after the movable electrode 5 has contacted the second fixed electrodes 3b (i.e., the movable electrode 5 has been displaced to the first position), the movable electrode 5 cannot be deformed any further. Therefore, the load exerted on the movable electrode 5 and the pressing member 6A again increases. The protruding portion 6b is elastically deformed so as to collapse further in the same way as shown in FIG. 6A, whereupon the volume of a portion of the pressing member 6A situated in the recess 2a of the case 2 gradually increases.

The operation member 10 is downwardly displaced by additional elastic deformation of the pressing member 6A, whereupon a portion of the operation member 10 contacts the resin layer 6c of the pressing member 6A in the same way as shown in FIG. 6B. The operation member 10 is supported on the upper surface 2b of the case 2 by way of the flat portion 6a. A dimension of the protruding portion 6b and a dimension of the recess 2a are respectively determined such that the entirety of the protruding portion 6b elastically deformed in this state is housed in the recess 2a of the case 2.

Even when the pressing force is further continually exerted on the operation member 10 in this state, the load is received by the upper surface 2b of the case 2, so that additional load is not exerted on the movable electrode 5 and the pressing member 6A.

When the pressing force exerted on the operation member 10 is canceled, the center portion 5b restores an upward swell with tactile feel by self restoration force (elasticity) of the movable electrode 5 (i.e., the movable electrode 5 is displaced to the second position), whereupon the first fixed electrodes 3a and the second fixed electrodes 3b are released from an electrically conducted state. The operation member 10 is pushed back upwardly by the self restoration force (elasticity) of the pressing member 6A, as a result of which the operation member 10 returns to its initial state shown in FIG. 7A.

The configuration of the embodiment yields an advantage similar to that described in connection with the switch 1 of the first embodiment. Further, the protruding portion 6b of the pressing member 6A opposes the movable electrode 5 at a position below the resin layer 6c and the supporting portion 6d and remains unexposed through an exterior surface of the switch 1A. Therefore, infliction of damage on the protruding portion 6b, which would otherwise be caused by interference with another member, or the like, can be avoided, and deterioration of feeling of switching operation can be prevented.

The embodiment is intended for facilitating comprehension of the invention and will not limit the invention. As a matter of course, the invention is susceptible to alterations or modifications without departing the gist of the invention, and equivalents shall be included in the invention.

In the first embodiment, the flat portion 6a, the protruding portion 6b and the resin layer 6c are not limited to be formed as independent layers which are made of separated materials respectively. As long as the pressing member 6A can be elastically deformed, the flat portion 6a, the protruding portion 6b and the resin layer 6c may be integrated by a same material suitably selected.

In the second embodiment, the supporting portion 6d, the protruding portion 6b and the resin layer 6c are not limited to be formed as independent layers which are made of separated materials respectively. As long as the pressing member 6A can be elastically deformed, the supporting portion 6d, the protruding portion 6b and the resin layer 6c may be integrated by a same material suitably selected.

The words “upward” and “downward” employed in the embodiment are used as required merely for convenience in the descriptions for which a reference has been made to the drawings and are not intended to limit the orientation of a product in use. The words “upward” and “downward” can be replaced with a “direction of an increasing distance from a circuit board” and a “direction of an approach to a circuit board.”

The shape and number of the protruding portion 6b of the pressing member 6 are not limited to the mode described in connection with the embodiment. The shape and number of the protruding portion 6b can be determined appropriately in conformity with specifications of the push switch 1 and the operating member 10.

The movable electrode 5 can assume an appropriate shape and configuration, so long as the movable electrode 5 can be displaced from a position where the movable electrode can bring the plurality of fixed electrodes out of electrical conduction by means of the pressing member 6 to a position where the movable electrode can bring the fixed electrodes into electrical conduction by means of the same. The movable electrode 5 does not always need to exhibit elasticity.

According to the invention, the pressing member is elastically deformed while displacement of the movable electrode caused by the pressing force. Therefore, local concentration of stress on an area between the movable electrode and the pressing member can be avoided.

The invention makes it possible to prevent local concentration of stress, which would otherwise arise in an area between a movable electrode and a pressing member. Therefore, it is possible to extend operating life of a switch by curtailing load on the movable electrode while fulfilling a request for miniaturization of a switch.

What is claimed is:

1. A switch comprising:
a case, configured to be mounted on a circuit board, and formed with a recess;
a plurality of fixed electrodes provided in the recess;
a movable electrode, provided in the recess, and configured to be displaced between a first position where the plurality of fixed electrodes are electrically connected to each other and a second position where the plurality of fixed electrodes are insulated from each other; and
a pressing member, covering the recess, and configured to displace the movable electrode from the second position to the first position when a pressing force from outside is applied to the pressing member, wherein
the pressing member is configured to be elastically deformed by the pressing force so that a contact area between the pressing member and the movable electrode is increased.

2. The switch according to claim 1, wherein
the pressing member includes a first part entirely covering the movable electrode and a second part protrudes from the first portion in a direction in which the movable electrode is displaced, and
the first part and the second part are integrated.

3. The switch according to claim 1, wherein
the pressing member is made from a material containing silicon rubber or fluorine-based rubber.

4. The switch according to claim 1, wherein
the pressing member includes a resin layer is provided on a surface thereof facing the movable electrode.

5. The switch according to claim 4, wherein
the resin layer is made from a material containing any one of polyimide, a PEEK resin, and a fluorine-based resin.

6. The switch according to claim 1, wherein
the movable electrode has elasticity.

7. A switch comprising:
a case, configured to be mounted on a circuit board, and formed with a recess;
a plurality of fixed electrodes provided in the recess;
a movable electrode, provided in the recess, and configured to be displaced between a first position where the plurality of fixed electrodes are electrically connected to each other and a second position where the plurality of fixed electrodes are insulated from each other; and
a pressing member, covering the recess, and configured to displace the movable electrode from the second position to the first position when a pressing force from outside is applied to the pressing member, wherein
the pressing member is configured to be elastically deformed by the pressing force so that a volume of a portion of the pressing member situated in the recess in a state where the movable electrode is displaced to the first position is increased.

8. The switch according to claim 7, wherein
the pressing member includes a first part entirely covering the movable electrode and a second part protrudes from the first portion in a direction in which the movable electrode is displaced, and
the first part and the second part are integrated.

9. The switch according to claim 7, wherein
the pressing member is made from a material containing silicon rubber or fluorine-based rubber.

10. The switch according to claim 7, wherein
the pressing member includes a resin layer is provided on a surface thereof facing the movable electrode.

11. The switch according to claim 10, wherein
the resin layer is made from a material containing any one of polyimide, a PEEK resin, and a fluorine-based resin.

12. The switch according to claim 7, wherein
the movable electrode has elasticity.
